(19) United States
(12) Patent Application Publication
(10) Pub. No.: US 2019/0182591 A1
(43) Pub. Date: Jun. 13, 2019

(54) DEVICE FOR CALIBRATING MICROPHONES

(71) Applicants: AATON DIGITAL, VERNEUIL SUR AVRE (FR); SAS ITHAKI, VERNEUIL SUR AVRE (FR)

(72) Inventor: Jacques DELACOUX, RUEIL LA GADELIERE (FR)

(21) Appl. No.: 16/322,797

(22) PCT Filed: Jul. 31, 2017
(86) PCT No.: PCT/FR2017/052148

§ 371 Date: Feb. 1, 2019

(30) Foreign Application Priority Data
Aug. 1, 2016 (FR) 1657451

(51) Int. Cl. H04R 3/04; H04R 29/00; H04R 3/00

(52) U.S. Cl. CPC H04R 3/04; H04R 29/004; H04R 2201/028; H04R 3/005; H04R 29/001

(57) ABSTRACT

The invention concerns a calibration device including a sound recording system including microphones coupled to an audio signal processing device, the calibration device further including an enclosure at least partly containing the processing device, a sound generator coupled to the processing device, and a support of the microphones capable of maintaining the microphones at the same distance from the sound generator.

The present patent application claims the priority benefit of French patent application FR16/57451 which is herein incorporated by reference.

### BACKGROUND

The present application concerns a device and a method of calibration of microphones in an electronic system, particularly a sound recording system.

### DISCUSSION OF THE RELATED ART

Certain electronic systems, particularly sound recording systems, may comprise a plurality of microphones, particularly to improve the quality of the recorded acoustic information and/or to extract information relative to the sound sources and/or to the surroundings.

FIG. 1 partially and schematically shows an example of a sound recording system 10 comprising a plurality of microphones 12 which are distributed on the site 14 where the sound recording is performed. Microphones 12 are coupled to an audio signal processing device 16. Microphones 12 transmit to processing device 16 analog or digital electric signals originating from the conversion of the sound waves, and processing device 16 applies a processing to the digital audio signals based on the signals supplied by the microphones, and for example generates and stores digital audio files.

During the processing of the signals supplied by microphones 12, processing device 16 generally operates by default as if the properties of microphones 12 were identical. An example of property is the delay between the time of reception of a sound wave by microphone 12 and the time at which processing device 16 starts performing a processing on the digital audio signal obtained by analog-to-digital conversion of the signal picked-up by microphone 12. Such a delay is called transmission delay hereafter. Other examples of properties of the microphone are the phase shift and the gain at the conversion of the sound signal.

However, the properties of microphones 12 are generally not identical. For example, the transmission delays associated with the microphones are generally not identical and should be taken into account on generation of the audio files by processing device 16, so that, when the audio files are listened to, a proper sound reproduction is obtained. Transmission delays particularly differ between analog microphones and digital microphones. An analog microphone transmits to the processing device an analog signal representative of the sound waves received by the microphone and the processing device performs the analog-to-digital conversion of the analog signal. An analog microphone is generally coupled to the processing device by a wire connection so that the duration of the transfer of the analog signal from the analog microphone to the processing device is negligible. A digital microphone comprises a digital-to-analog converter which converts the analog signal originating from the conversion of the sound signal into a digital signal transmitted to the processing device. Further, the transmission of the signals from the digital or analog microphone to processing device 16 may be a wireless transmission implementing electromagnetic waves. The transmission delay of the microphone then further comprises the delay for the transmission and the reception of the electromagnetic waves and also the delay for the possible coding and error correction processing carried out by the transmitter. FIG. 1 schematically shows four microphones 12, among which three microphones 12 coupled to processing device 16 by a wire connection 18 and one microphone 12 coupled to processing device 16 by a wireless connection 20.

For certain applications, it may be necessary to provide a step of calibration of sound recording system 10 to determine the differences between the properties of microphones 12 and possibly determine means of compensation of such differences. As an example, the compensation of the differences between the transmission delays of microphones 12 may comprise the addition by an operator of variable delays, stored by processing device 16, so that the times of beginning of audio file recording are identical. As an example, the compensation of the differences between the amplification ratios and the phase shifts of microphones 12 may comprise the addition of a filtering applied by processing device 16 to the signals supplied by microphones 12 so that the recorded audio files correspond to the audio files which would be obtained if the amplification ratios and the phase shifts of microphones 12 were identical.

An example of a method of calibrating sound recording system 10 comprises the emission by a sound generator 24, for example, a loudspeaker, possibly controlled by processing device 16, of a plurality of known sequences of sound signals, and the analysis of the audio files supplied by processing device 16 after the acquisition of the sound signal sequences by microphones 12.

There exists a delay of propagation of each sound signal from loudspeaker 24 to each microphone 12. This delay may vary from one microphone to the other according to the relative position of microphone 12 and loudspeaker 24. A disadvantage is that it can then be difficult, based on the analysis of the audio files, to separate, for each microphone 12, the transmission device associated with microphone 12 from the propagation delay.

It may then be difficult to automatically adapt the compensation means determined at the calibration to a new arrangement of the microphones, and an operator then generally has to perform a manual adaptation of the compensation means for each new arrangement of the microphones, which is a long and tedious operation.

### SUMMARY

An object of an embodiment is to provide a device of calibration of a sound recording system which overcomes all or part of the disadvantages of the previously-described devices.

Another object of an embodiment is for the calibration to be performed automatically.

Another object of an embodiment is for the calibration to be performed simply.

Another object of an embodiment is for the calibration to be performed rapidly.

Thus, an embodiment provides a calibration device comprising a sound recording system comprising microphones coupled to an audio signal processing device, the calibration device further comprising an enclosure at least partly containing the processing device, a sound generator coupled to the processing device, and a support of the microphones capable of maintaining the microphones at the same distance from the sound generator.

According to an embodiment, the device further comprises a battery of accumulators.

According to an embodiment, the sound generator is located between the support and the processing device.

According to an embodiment, the sound generator is in contact with the support.

According to an embodiment, the support is at least partly made of a resilient material.

According to an embodiment, the support comprises holes receiving the microphones, and at least one of the holes has a shape at least partly complementary to that of one of the microphones.

According to an embodiment, the minimum distance separating each microphone from the sound generator is shorter than 20 cm.

According to an embodiment, the number of microphones is greater than or equal to five.

An embodiment also provides the use of a calibration device such as previously defined for the calibration of the microphones of the sound recording system.

According to an embodiment, the use comprises the steps of:

emission of at least one sound signal by the sound generator;

picking-up of the sound signal by each microphone and, for each microphone, acquisition of a digital audio signal by the processing device; and

analysis of the digital audio signals to determine, for each microphone, at least one feature from among the transmission delay, the phase shift, and the conversion gain of the microphone.

According to an embodiment, the use further comprises the step of addition, for at least one of the microphones, of a delay by the processing device on subsequent acquisitions of digital audio signals representative of sound signals picked up by said microphone.

### BRIEF DESCRIPTION OF THE DRAWINGS

The foregoing and other features and advantages will be discussed in detail in the following non-limiting description of specific embodiments in connection with the accompanying drawings, among which:

FIG. 1, previously described, partially and schematically shows an example of a sound recording system;

FIGS. 2 and 3 are partial simplified cross-section views of an embodiment of a device of calibration of a sound recording system;

FIG. 4 is a partial simplified cross-section view, similar to FIG. 3, of another embodiment of a device of calibration of a sound recording system;

FIG. 5 is a block diagram of an embodiment of a method of calibration of a sound recording system;

FIG. 6 shows an example of envelope of an audio signal emitted by a loudspeaker and the digital audio signals acquired by a processing device of the calibration device of FIG. 2 on implementation of the calibration method illustrated in FIG. 5; and

FIG. 7 is a block diagram of a more detailed embodiment of a step of the calibration method illustrated in FIG. 5.

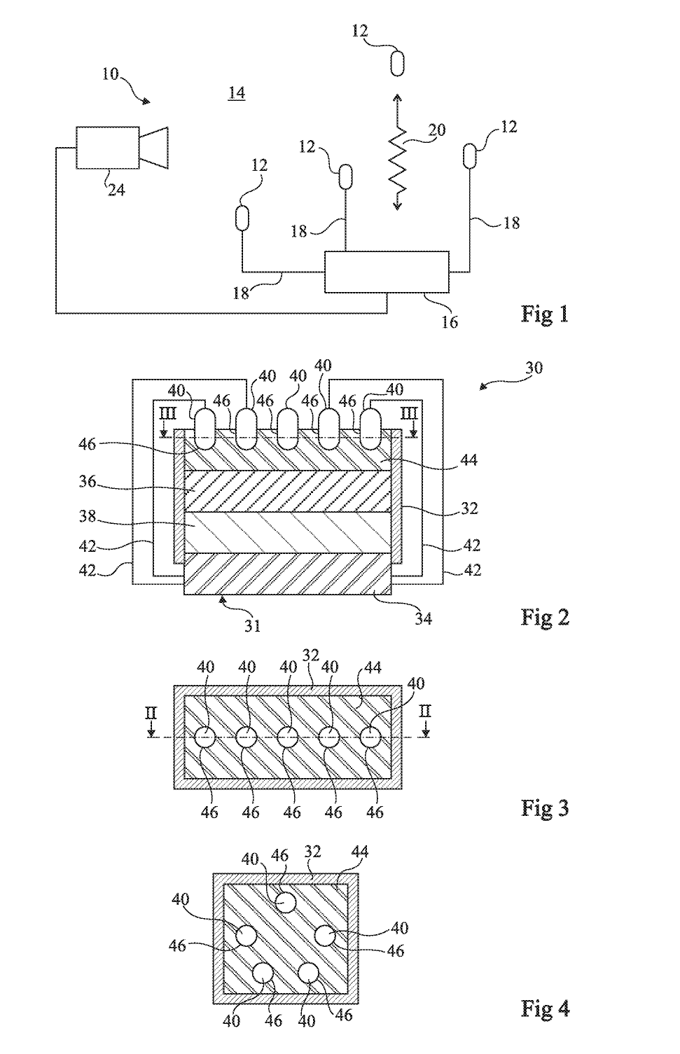

### DETAILED DESCRIPTION

The same elements have been designated with the same reference numerals in the different drawings. For clarity, only those elements which are useful to the understanding of the described embodiments have been shown and are detailed. In particular, the structures of microphones and of a device for processing the sounds picked up by microphones are well known and will not be described in detail hereafter.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, such as terms “horizontal”, “vertical”, etc., it is referred to the orientation of the drawings or to a sound recording system in a normal position of use. The terms “approximately”, “substantially”, and “in the order of” are used herein to designate a tolerance of plus or minus 10%, preferably of plus or minus 5%, of the value in question.

According to an embodiment, for the calibration of microphones, it is provided to arrange the microphones close to a loudspeaker in a fixed and known configuration. The relative position between each microphone and the loudspeaker is then previously known. Preferably, the microphones are arranged so that the propagation device of the sound waves from the loudspeaker to each microphone is substantially constant. The determination of the transmission delays of the microphones is then eased. In the following description, the terms “sound signal” and “acoustic signal” are indifferently used.

FIGS. 2 and 3 are partial simplified cross-section views of an embodiment of a device 30 of calibration of a sound recording system 31.

Calibration device 30 comprises an enclosure 32 having the components of sound recording system 31 arranged therein, particularly a sound signal processing device 34. Enclosure 32 further contains a sound generator 36, for example, a loudspeaker, preferably coupled to processing device 34 and controlled by processing device 34. Loudspeaker 36 may be coupled to processing device 34 by a wire connection or be controlled by processing device 34 over a wireless connection, particularly implementing electromagnetic waves. Loudspeaker 36 is preferably located above processing device 34. Processing device 34 for example corresponds to the product commercialized by Aaton-Digital under trade name Cantar-X3. Processing device 34 may comprise a dedicated electronic circuit and/or a processor, for example, a microcontroller, capable of executing the instructions of a computer program stored in the memory. Loudspeaker 36 may be a wideband loudspeaker. A battery of electric accumulators 38 for the power supply of processing device 34 and/or of loudspeaker 36 may be arranged in enclosure 32. Battery 38 may be located between processing device 34 and loudspeaker 36. As a variation, processing device 34 may be located between loudspeaker 36 and battery 38.

According to an embodiment, loudspeaker 36 and/or battery 38 of electric accumulators may be totally or partly integrated to processing device 34.

Sound recording system 31 further comprises microphones 40 coupled to processing device 34. The number of microphones 40 may be in the range from 2 to 50, preferably from 2 to 20. As an example, in FIGS. 2 and 3, a processing device 34 coupled to five microphones 40 has been shown. Each microphone 40 may be coupled to processing device 34 by a wire connection or by a wireless connection implementing the transmission of electromagnetic waves. As an example, in FIG. 2, five microphones 40 have been shown, among which two microphones, each coupled to processing device 34 by a cable 42, and one microphone transmits signals to processing device 34 over a wireless connection, not shown.

Each microphone 40 comprises a transducer capable of receiving an acoustic signal S(t) and of converting it into an analog electric signal Sₑ(t), also called analog audio signal, where t indicates a time variable. Each microphone 40 has a transfer function H which, in the frequency range, is provided by the following relation (1):

H(ω)=A(ω)exp(iΦ(ω)) (1)

where ω is the pulse of the acoustic signal, A is the conversion gain, which may depend on frequency, and Φ is the phase shift, which may depend on frequency.

Processing device 34 is capable of determining, for each microphone 40, a digital audio signal Sₙ based on analog audio signal Sₑ(t). Microphone 40 may transmit analog audio signal Sₑ(t) to processing device 34, which then converts the analog audio signal to obtain digital audio signal Sₙ. As a variation, microphone 40 may perform the analog-to-digital conversion of analog audio signal Sₑ(t) and directly supply digital audio signal Sₙ to processing device 34. For each microphone 40, processing device 34 is capable of performing a processing on digital audio signal Sₙ to supply a digital audio file. The processing may comprising conditioning digital audio signal Sₙ, for example, applying a filter to the digital audio signal, mixing the digital audio signal with another digital audio signal, and/or recording the digital audio signal comprising digital audio signal Sₙ and possibly additional data. The transmission delay of microphone 40 corresponds to the delay between the time when the microphone starts receiving sound signal S(t) and the time when processing device 34 starts the processing applied to the digital audio signal, for example, the time when processing device 34 starts conditioning digital audio signal Sₙ, the time when processing device 34 starts mixing digital audio signal Sₙ with another digital signal, or the time when processing device 34 starts storing the digital audio file representative of sound signal S(t).

Calibration device 30 further comprises a support 44 at least partially arranged in enclosure 32 and comprising holes 46 having microphones 40 at least partly arranged therein. Preferably, support 40 is in contact with loudspeaker 36. According to an embodiment, support 44 comprises a resilient material at least at the level of each hole 46 so that support 44 may slightly deform on introduction of microphone 40 into hole 46. Support 44 is for example at least partly made of foam. According to an embodiment, each hole 46 has a shape complementary to a portion of a microphone 40 so that, when a microphone 40 is arranged in a hole 46, microphone 40 remains substantially stationary with respect to enclosure 32, for example, by the friction exerted by support 44 on microphone 40. The holes 46 present in support 44 may be identical. As a variation, holes 46 may have different shapes in the case where microphones having different shapes are used. In FIG. 3, holes 46 are shown as being aligned.

According to an embodiment, enclosure 32 may be a monoblock part or comprise a plurality of parts coupled to one another. According to an embodiment, enclosure 32 may comprise a frame having an inner wall having a shape complementary to that of the different elements housed in enclosure 32. As a variation, wedges may further be arranged in enclosure 32, between enclosure 32 and processing device 34, battery 38, loudspeaker 36, and/or support 44, to ease the holding in position of these elements in enclosure 32. As an example, enclosure 32 is made of resilient material.

FIG. 4 is a view similar to FIG. 3 of another embodiment of support 44 where holes 46 are arranged at the corners of a regular polygon. As a variation, holes 46 may be distributed in rows and in columns.

According to another embodiment, support 44 may comprise a plurality of microphone clamps, preferably coupled by a rigid frame to one another, each microphone 40 being held by one of the clamps on use of calibration device 30.

When microphones 40 are arranged on support 44, the capsules of microphones 40 are preferably placed relative to loudspeaker 36 so that the sound waves emitted by the loudspeaker are substantially planar when they reach microphones 40 and reach at the same time the capsules of microphones 40. According to an embodiment, the capsules of microphones 40 are arranged at an equal distance from loudspeaker 36.

According to an embodiment, the distance between the capsule of each microphone 40 and loudspeaker 36 is in the range from 2 cm to 20 cm, preferably from 2 cm to 10 cm.

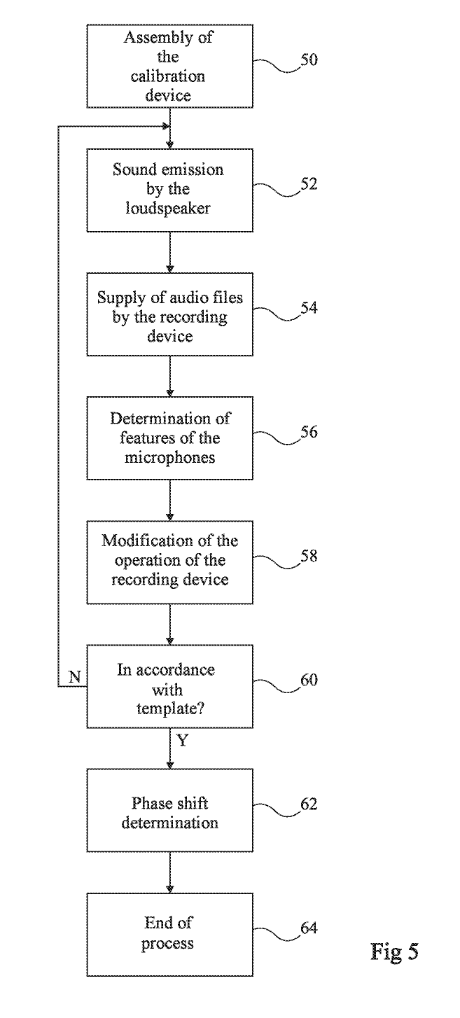

FIG. 5 shows an embodiment of a method of calibration of sound recording system 31.

Step 50 corresponds to the assembly of calibration device 30, which comprises stacking, in enclosure 32, processing device 34, battery 38, loudspeaker 36, and support 44. Enclosure 32 holds processing device 34, battery 38, loudspeaker 36, and support 44 in position. Enclosure 32 ensures that microphones 40 remain stationary relative to loudspeaker 36 during the calibration operation. The method carries on at step 52.

At step 52, sound signals are emitted by loudspeaker 36. The sound signals are picked up by microphones 40. Each sound signal may correspond to a pure sound emitted for a determined emission time period, that is, to a sound signal at a single frequency. The frequency of the pure sound may be constant during the emission time period or may vary during the emission time period. As an example the frequency of the pure sound may increase or decrease with a constant variation rate during the emission time period, which corresponds to a frequency ramp. The method carries on at step 54.

At step 54, for each microphone 40, a digital audio signal Sₙ is acquired by processing device 34 from the sound signal picked up by the microphone at step 52, where digital audio signal Sₙ may be received or determined by processing device 34. As previously described, the processing device may perform various processings on digital audio signals Sₙ, and particularly supply and store audio files.

Steps 52 and 54 are repeated from each sound signal supplied by loudspeaker 36. The method carries on at step 56.

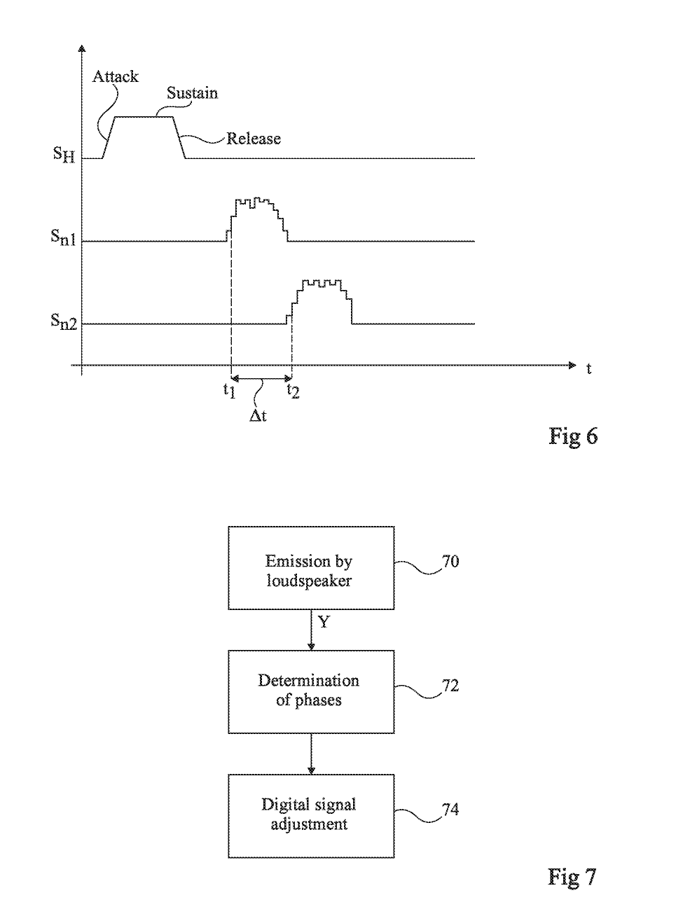

FIG. 6 schematically shows an example of envelope S_{H} of the control signal of loudspeaker 36 for the emission of a sound signal and digital audio signals Sₙ₁ and Sₙ₂ acquired by processing device 34 from the sound signals which are picked up by two microphones 40 on emission of the sound signal by loudspeaker 36. Envelope S_{H} for example successively comprises a rising edge Attack, a steady level area Sustain, and a falling edge Release. However, other shapes of envelope S_{H} may be used. Time t₁ corresponds to the time of detection of the rising edge of signal Sₙ₁ and time t₂ corresponds to the time of detection of the rising edge of signal Sₙ₂. Call Δt the delay of time t₂ with respect to time t₁.

Referring again to FIG. 5, at step 56, features of microphones 40 are determined by processing device 34 based on the analysis of the digital audio signals Sₙ supplied at step 54. The features may be the transmission delay, the phase shift, and/or the amplification ratio of each microphone 40. Advantageously, since the shape of support 44 is previously known, the relative positions between the microphones 40 placed in holes 46 and loudspeaker 36 are previously known. The propagation delay of each sound signal from loudspeaker 36 to each microphone 40 is thus previously known. Further, preferably, the configuration of microphones 40 is defined so that the propagation delays of each sound signal emitted by loudspeaker 36 to microphones 40 are substantially identical.

An example of a method of analyzing the digital audio signals is described in patent application FR 2764088. The analysis method may comprise comparing the digital audio signals with one another. As an example, for each sound signal emitted by loudspeaker 36 and for each pair of microphones comprising a first microphone and a second microphone, the analysis method may comprise determining delay Δt between time t₁ of beginning of first digital audio signal Sₙ₁ relative to time t₂ of beginning of the second digital audio signal Sₙ₂ such as acquired by processing device 34. As an example, the time of beginning of a digital audio signal may correspond to the time at which the digital audio signal exceeds a threshold. According to another example, the digital audio signal is compared with a template by displacement in time of the template with respect to the digital audio signal until a criterion is fulfilled, for example, the maximum coverage of the digital audio signal by the template. The time of beginning of the digital audio signal is then obtained from the determined position of the template.

As a variation, rather than a processing applied to the two digital audio signals associated with a pair of microphones 40, a simultaneous processing of more than two digital audio signals associated with more than two microphones 40 may be performed.

At step 58, processing device 34 may modify some of its operating parameters according to the results obtained at step 56. According to an embodiment, processing device 34 is capable of modifying, for each microphone 40, the delay between the real beginning of the digital audio signal acquired by processing device 34 and corresponding to an audio signal picked up by microphone 40 and the beginning of the processing applied by processing device 34 to the digital audio signal. Such a delay is called waiting delay hereafter. As a variation, the processing device may shift the time of beginning of the digital audio signal by a time period equal to the waiting delay.

According to an embodiment, processing device 34 automatically modifies the waiting delays associated with the microphones so that the processings of the digital audio signals by the processing device start simultaneously, as if the times of beginning of the digital audio signals were identical. According to an embodiment, at step 56, processing device 34 determines for which microphone 40 delay Δt is the longest and, at step 58, the waiting delays associated with the other microphones are then modified so that the time of beginning of each digital audio signal corresponds to the time of beginning of the digital audio signal having the longest delay.

Independently from what has been previously described, the processing performed by processing device 34 may comprise introducing an additional delay for certain digital audio signals, particularly by delaying the beginning of the recording of digital audio files, for example, to obtain a desired sound effect (the creation of an echo, the obtaining of a distance perception, etc.).

At step 60, processing device 34 determines whether the digital audio signals fulfill certain criteria. If the digital audio signals do not fulfill the criteria, the method returns to step 52 and a new calibration operation is implemented. As an example, the digital audio signals may be compared with templates. If the digital audio signals fulfill the criteria, the method carries on at step 62.

At step 62, processing device 34 determines the phase shift between digital audio signals acquired by processing device 34 from the sound signals picked up by microphones 40. Step 62 may be omitted.

At step 64, processing device 34 may indicate to an operator that the calibration operation is over. As an example, it may be provided to display information on a display screen indicating the delay associated with each microphone 40.

FIG. 7 shows a more detailed embodiment of a method of determination of the phases of the audio signals at previously-described step 62.

At step 70, sound signals are emitted by loudspeaker 36. The sound signals are picked up by microphones 40. Each sound signal corresponds to a pure sound emitted for a determined emission time, that is, to a sound signal at a single frequency. The frequency of the pure sound may be constant during the emission time period or may vary during the emission time period. As an example, the frequency of the pure sound may increase or decrease with a constant variation rate during the emission time period, which corresponds to a frequency ramp.

At step 72, for each sound signal and for each pair of microphones comprising a first microphone and a second microphone, processing device 34 may determine the sum of the first digital audio signal associated with the first microphone and of the second digital audio signal associated with the second microphone to determine the phase shift between the first and second digital audio signals.

At step 74, processing device 34 may modify digital audio signals Sₙ to compensate for the phase shifts determined at step 72. According to an embodiment, at step 74, processing device 34 determines the digital audio signal having a correct phase and the digital audio signals which do not have the right phase are modified. As an example, the correct phase corresponds to the phase common to the greatest number of digital audio signals among all the signals acquired by processing device 34.

Steps 52 to 64 of the calibration of microphones 40 of sound recording system 31 may advantageously be carried out rapidly and automatically by recording device 31.

Specific embodiments have been described. Various alterations, modifications, and improvements will readily occur to those skilled in the art.

1. A calibration device comprising a sound recording system comprising microphones coupled to an audio signal processing device, the calibration device further comprising an enclosure at least partly containing the processing device, a sound generator coupled to the processing device, and a support of the microphones capable of maintaining the microphones at the same distance from the sound generator, the processing device being capable of commanding the emission of at least one sound signal by the sound generator, each microphone being capable of picking up the sound signal, the processing device being capable, for each microphone, of acquiring a digital audio signal, the processing device being capable of analyzing the digital audio signals to determine, for each microphone, the transmission delay of the microphone, and of adding, for at least one of the microphones, a delay on subsequent acquisitions of digital audio signals representative of sound signals picked up by said microphone.

2. The device of claim 1, further comprising a battery of accumulators.

3. The device of claim 1, wherein the sound generator is located between the support and the processing device.

4. The device of claim 1, wherein the sound generator is in contact with the support.

5. The device of claim 1, wherein the support is at least partly made of a resilient material.

6. The device claim 1, wherein the support comprises holes receiving the microphones, at least one of the holes having a shape at least partly complementary to that of one of the microphones.

7. The device claim 1, wherein the minimum distance separating each microphone from the sound generator is shorter than 20 cm.

8. The device claim 1, wherein the number of microphones is greater than or equal to five.

9. A use of the calibration device of claim 1 for the calibration of the microphones of the sound recording system, comprising the steps of:
emission of at least one sound signal by the sound generator;
picking up of the sound signal by each microphone and, for each microphone, acquisition of a digital audio signal by the processing device;
analysis of the digital audio signals to determine, for each microphone, at least one feature from among the transmission delay, the phase shift, and the conversion gain of the microphone;
addition, for at least one of the microphones, of a delay by the processing device on subsequent acquisitions of digital audio signals representative of sound signals picked up by said microphone.

10. The use of claim 9, further comprising the step of analyzing the digital audio signals to determine, for each microphone, at least one feature among the phase shift and the conversion gain of the microphone.
